(19) United States
(12) Patent Application Publication
(10) Pub. No.: US 2008/0246186 A1
(43) Pub. Date: Oct. 9, 2008

(54) COMPOSITION AND METHOD FOR MAKING POLYARYLENE ETHER COPOLYMERS

(76) Inventors: Scott Michael Fisher, Delmar, NY (US); Susanta Banerjee, Kharagpur (IN); Subramanya Kishore Avadhanula Venkata, Bangalore (IN); Anatharaman Dhanabalan, Bangalore (IN); Vijay R. Mhetar, Slingerlands, NY (US); Abhijit Namjoshi, Slingerlands, NY (US)

Correspondence Address: General Electric Company;Global Patent Operation, 187 Danbury Road, Suite 204, Wilton, CT, 06897-4122, US

(21) Appl. No.: 11/697,811

(22) Filed: Apr. 9, 2007

(51) Int. Cl. C08G 65/38; B29B 7/00; C08K 3/10

(52) U.S. Cl. 264/328.1; 524/436; 524/540; 528/212; 528/214; 528/216; 528/219; 528/86

(57) ABSTRACT

A method for making a polyarylene ether copolymer including mixing a polyarylene ether, a hydroxyaromatic terminated siloxane reagent and an oxidant, and melt compounding the mixture. A polyarylene ether copolymer including a polyarylene ether, a hydroxyaromatic terminated siloxane reagent, an oxidant and a filler is also presented.

### FIELD OF THE INVENTION

The present invention is for a process for making polyarylene ether and siloxane copolymers and more particularly, to preparing the copolymers by melt compounding.

### BACKGROUND OF THE INVENTION

Polyphenylene ethers are a widely used class of thermoplastic engineering resins characterized by excellent hydrolytic stability, dimensional stability, toughness, heat resistance and dielectric properties. However, they are deficient in certain other properties including workability, mechanical properties, such as heat deflection temperature, ductility, and flame retardancy. Therefore, there is a continuing search for a means to modify polyphenylene ethers to improve these other properties.

U.S. Pat. No. 5,596,048 discloses a redistribution method for making copolymers of polyarylene ethers and siloxanes in solution comprising contacting high molecular weight polyarylene ethers with a hydroxyaromatic terminated siloxane reagent in the presence of an oxidant and an organic solvent. The resulting polyarylene ether copolymer has a lower molecular weight than the starting polyarylene ether.

Preparation of a polyarylene ether-siloxane copolymer in solution is not easily scalable for commercial preparation, because it requires large quantities of solvent for reaction, a long reaction time and needs subsequent work-up, such as precipitating the resulting polymer. Also, the redistribution reaction creates a copolymer with lower molecular weight.

What is needed is a method of preparing a polyarylene ether-siloxane copolymer that is easily scalable to commercial production, is prepared via cost effective methods, maintains the molecular weight of the components and provides a copolymer with good flame retardancy and mechanical properties in a shorter reaction time.

### SUMMARY OF THE INVENTION

In one embodiment, a method for making a polyarylene ether copolymer comprises mixing a polyarylene ether, a hydroxyaromatic terminated siloxane reagent and an oxidant, and melt compounding the mixture.

In another embodiment, a composition comprises a polyarylene ether, a hydroxyaromatic terminated siloxane reagent and processing aid.

In another embodiment, a composition comprises a polyarylene ether, a hydroxyaromatic terminated siloxane reagent, oxidant and filler.

The various embodiments provide a method for making a polyarylene ether copolymer that is easily scalable to commercial production, cost effective and has a shorter reaction time and produces a polyarylene ether copolymer having improved flame retardancy, good mechanical properties and increased molecular weight over copolymers prepared in solution.

### BRIEF DESCRIPTION OF DRAWINGS

FIG. 1 depicts an NMR scan of the polyarylene ether copolymer prepared in Example 2.

### DESCRIPTION

The singular forms “a,” “an” and “the” include plural referents unless the context clearly dictates otherwise. The endpoints of all ranges reciting the same characteristic are independently combinable and inclusive of the recited endpoint. All references are incorporated herein by reference.

The modifier “about” used in connection with a quantity is inclusive of the stated value and has the meaning dictated by the context (e.g., includes the tolerance ranges associated with measurement of the particular quantity).

“Optional” or “optionally” means that the subsequently described event or circumstance may or may not occur, or that the subsequently identified material may or may not be present, and that the description includes instances where the event or circumstance occurs or where the material is present, and instances where the event or circumstance does not occur or the material is not present.

In one embodiment, a method for making a polyarylene ether copolymer comprises mixing a polyarylene ether, a hydroxyaromatic terminated siloxane reagent and an oxidant, and melt compounding the mixture.

The polyarylene ether may be any type of polyarylene ether. In one embodiment, the polyarylene ether has the structure (1):

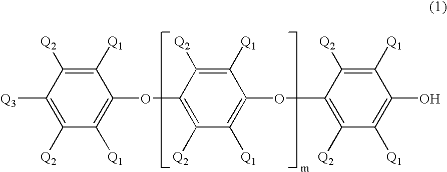

wherein each Q₁ is independently hydrogen, a primary or secondary alkyl group having from 1 to 7 carbon atoms, phenyl, haloalkyl, aminoalkyl, hydrocarbonoxy, or halohydrocarbonoxy wherein at least two carbon atoms separate the halogen and oxygen atoms; each Q₂ is independently hydrogen, halogen, a primary or secondary alkyl group having from 1 to 7 carbon atoms, phenyl, haloalkyl, aminoalkyl, hydrocarbonoxy, or halohydrocarbonoxy wherein at least two carbon atoms separate the halogen and oxygen atoms; Q₃ is a hydrogen, a hydroxyl group or a mixture thereof, and m is an integer having an average value in the range from about 3 to about 300.

In one embodiment, the alkyl groups include methyl, ethyl, n-propyl, n-butyl, n-amyl, isoamyl, 2-methylbutyl, n-hexyl, 2,3-dimethylbutyl, 2-, 3-, or 4-methylpentyl and the corresponding heptyl groups; isopropyl, sec-butyl, and 3-pentyl.

In one embodiment, Q₁ is phenyl or a primary alkyl radical having from 1 to 4 carbon atoms. In another embodiment, Q₁ is methyl and Q₂ is hydrogen. In one embodiment, m has a value in the range from about 15 to about 200.

In one embodiment, the polyarylene ether may be a polyphenylene ether. The polyphenylene ether may be a homopolymer or a copolymer. In one embodiment, the homopolymer may comprise 2,6-dimethyl-1,4-phenylene ether units. In another embodiment, the copolymer may be graft, block or random copolymers comprising 2,6-dimethyl-1,4-phenylene ether units in combination with 2,3,6-trimethyl-1,4-phenylene ether units.

Polyarylene ethers are typically prepared by the oxidative coupling of at least one corresponding monohydroxyaromatic compound, such as 2,6-xylenol (wherein each Q₁ is methyl and each Q₂ is hydrogen) or 2,3,6-trimethylphenol (wherein each Q₁ and one Q₂ is methyl and the other Q₂ is hydrogen). A variety of catalyst systems are known, generally containing at least one heavy metal compound such as copper, manganese or cobalt compound, usually in combination with various other materials. In one embodiment, catalyst systems comprise copper compounds (e.g., cuprous or cupric ions, halide ions, and at least one amine) as described in U.S. Pat. Nos. 3,306,874, 3,306,875, 3,914,266, and 4,028,341, which are incorporated by reference herein. Manganese compounds are generally used in alkaline systems in which divalent manganese is present as complexes with one or more complexing and/or chelating agents such as dialkylamines, o-hydroxyaromatic aldehydes, o-hydroxyazo compounds, and gamma-hydroxyimines.

The polyarylene ether may have any molecular weight or intrinsic viscosity and is not limited. In one embodiment, the polyarylene ether has a number average molecular weight within the range of about 2000 to about 40,000 g/mol, including a range of about 2000 to about 25,000 g/mol and a range of about 3000 to about 12,000 g/mol. In another embodiment, the polyarylene ether has a weight average molecular weight within a range of about 6000 to about 80,000 g/mol, including a range of about 20,000 to about 60,000 g/mol, as determined by gel permeation chromatography. In one embodiment, the polyarylene ether has an intrinsic viscosity in the range of about 0.1 to about 1.3 dl/g, as measured in chloroform at 25° C. In another embodiment, the polyarylene ether has an intrinsic viscosity in the range of about 0.35 to about 0.6 dl/g, as measured in chloroform at 25° C. In one embodiment, the polyphenylene ether has an intrinsic viscosity of about 0.46 as measured in chloroform at 25° C.

The hydroxyaromatic terminated siloxane reagent may be any type of hydroxyaromatic terminated siloxane. In one embodiment, the hydroxyaromatic-terminated siloxane has the formula:

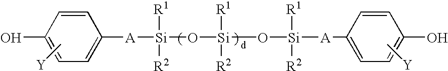

wherein each A is independently a direct link or a substituted or unsubstituted (C₁-C₁₅) alkyl or (C₂-C₁₅) alkylene; each Y is independently H, (C₁-C₆)alkyl or (C₁-C₆)alkoxyl, each R¹ and R² is independently H, a primary or secondary haloalkyl having from 1 to 12 carbon atoms, a primary or secondary alkyl group having from 1 to 12 carbon atoms, an aryl group having from 6 to 12 carbon atoms or an aralkyl group having from 7 to 18 carbon atoms; and d is an integer from 1 to 1,000,000.

In one embodiment, R¹ may be methyl, ethyl, propyl, butyl, phenyl, tolyl, xylyl and trifluoropropyl. In another embodiment, R² may be methyl, ethyl, propyl, butyl, phenyl, tolyl, xylyl and trifluoropropyl.

In one embodiment, d is an integer from 1 to 100,000. In another embodiment, d is an integer from 2 to 500 inclusive. In another embodiment, d is an integer from 5 to 200 inclusive.

In one embodiment, R¹ and R² are methyl groups, and d is an integer from 10 to 100.

In one embodiment, the hydroxyaromatic terminated siloxane reagent is a eugenol end-capped siloxane.

Hydroxyaromatic terminated siloxane reagents are commercially available. Hydroxyaromatic terminated siloxane reagents may also be prepared, for example, by the hydrosilation of a phenol, such as an allylphenol with a siloxane hydride, such as a hydride terminated dimethyl siloxane. A further description of the preparation of the siloxane reagent is found in U.S. Pat. No. 5,204,438, the disclosure of which is incorporated herein by reference.

The oxidant may be any type of oxidant that does not interfere with copolymer formation or generate radicals. In one embodiment, the oxidant includes air, oxygen, peroxides and quinones. In another embodiment, the oxidant comprises benzoylperoxide, dicumylperoxide, 1,1,4,4-tetramethyltetramethylene bis(tert-butyl peroxide), quinone, dimethylquinone, tetramethylquinone and tetramethyldiphenoquinone (TMDQ). The oxidants may be naturally occurring, commercially available, by-products of oxidative polymerizations or may be prepared via conventional methods, such as reacting an aryl acid halide and sodium peroxide in solution.

The polyarylene ether, hydroxyaromatic terminated siloxane reagent and oxidant may be mixed in any conventional manner. The order of addition of the polyarylene ether and hydroxyaromatic terminated siloxane reagent is not critical and these reactants may be added in any order. In one embodiment, the hydroxyaromatic terminated siloxane reagent may be premixed with a portion of the polyarylene ether. In another embodiment, the hydroxyaromatic terminated siloxane reagent is in liquid form and the polyarylene ether is in powder form and are premixed. The oxidant may be added simultaneously with the other reactants or may be added after the hydroxyaromatic terminated siloxane reagent, but should not be added before the hydroxyaromatic terminated siloxane reagent, as the oxidant may break down and decompose before the hydroxyaromatic terminated siloxane reagent can react with the polyarylene ether and oxidant to form the copolymer.

The reactants may be melt compounded in any conventional manner without the addition of a solvent. When preparing the polyarylene ether copolymers, any reaction vessel may be employed. In one embodiment, the reactants are melt compounded in an extruder.

The temperature for the melt compounding is at a temperature suitable for melting and reacting the reactants. In one embodiment, temperatures suitable for reactive melt conditions include temperatures in the range of from about 250° C. to about 340° C.

The extruder may be a single screw extruder or a twin-screw extruder. In one embodiment, the reactants are uniformly dispersed and fed to the throat of an extruder. In another embodiment, the oxidant may be fed at a separate location in the extruder from the other reactants. In one embodiment, the polyarylene ether and hydroxyaromatic terminated siloxane may be fed to the throat of the extruder and the oxidant is fed to the extruder downstream from the throat of the extruder. The reactants may be fed to the extruder by a liquid injection system. In one embodiment, the hydroxyaromatic terminated siloxane is added to the feedthroat of the extruder in liquid form. The oxidant may be added to the extruder simultaneously or after the hydroxyaromatic terminated siloxane reagent, but should not be added to the extruder before the hydroxyaromatic terminated siloxane reagent, as the oxidant may break down and decompose before the hydroxyaromatic terminated siloxane reagent can react with the polyarylene ether and oxidant to form the copolymer.

There is no limitation with respect to the amount of reactants used other than that the amounts employed result in copolymer formation. In one embodiment, the amount of hydroxyaromatic terminated siloxane reagent comprises up to about 11 percent by weight based on the weight of the mixture. In another embodiment, the amount of hydroxyaromatic terminated siloxane reagent comprises from about 0.5 to about 11 percent by weight based on the weight of the mixture. The amount of hydroxyaromatic terminated siloxane reagent includes an upper limit of about 11 percent by weight, about 10 percent by weight, about 5 percent by weight and about 3 percent by weight based on the weight of the mixture. The amount of hydroxyaromatic terminated siloxane reagent includes a lower limit of about 0.5 percent by weight, about 1 percent by weight, about 2 percent by weight and about 5 percent by weight based on the weight of the mixture. The lower limit amounts and the upper limit amounts are independently combinable to create ranges usable in the practice of the present invention. In another embodiment, the amount of hydroxyaromatic terminated siloxane reagent comprises from about 5 percent by weight to about 10 percent by weight of the mixture.

In one embodiment, the amount of polyarylene ether comprises from about 50 percent by weight to about 98.5 percent by weight based on the weight of the mixture. The amount of polyarylene ether includes an upper limit of about 98.5 percent by weight, about 97 percent by weight, about 95 percent by weight and about 90 percent by weight based on the weight of the mixture. The amount of polyarylene ether includes a lower limit of about 50 percent by weight, about 75 percent by weight, about 80 percent by weight and about 90 percent by weight based on the weight of the mixture. The lower limit amounts and the upper limit amounts are independently combinable to create ranges usable in the practice of the present invention.

In one embodiment, the oxidant is present in the amount of from about 0.5 to about 5 percent by weight based on the total weight of the mixture. In another embodiment, the oxidant is present in an amount of from about 0.7 to about 5 percent by weight based on the weight of the mixture. In another embodiment, the oxidant is present in an amount of from about 1 to about 2 percent by weight based on the total weight of the mixture.

In another embodiment, a processing aid may be added to the mixture to improve processability and other properties. In one embodiment, a composition comprises a polyarylene ether, a hydroxyaromatic terminated siloxane reagent and processing aid.

The processing aid segregates to the PPE phase lowering the viscosity of the PPE phase to bring it closer in value to the viscosity of the siloxane, which results in better overall dispersion.

The processing aid may be any type of processing aid. In one embodiment, the processing aid comprises a phosphate ester. In another embodiment, the processing aid comprises resorcinol diphosphate. In one embodiment, the processing aid may be used in an amount of from about 1 percent by weight to about 15 percent by weight based on the weight of the copolymer. In another embodiment, the amount of processing aid is used in an amount of from about 5 to about 10 percent by weight based on the weight of the copolymer.

In another embodiment, a filler may be added to the mixture to improve processability and other properties. In one embodiment, a composition comprises a polyarylene ether, a hydroxyaromatic terminated siloxane reagent, oxidant and filler. The filler may be a reinforcing filler. In another embodiment, the filler may be a silica or calcined aluminosilicate.

In one embodiment, the filler is a silica. The silica segregates to the siloxane phase, modifying its rheological properties to increase the viscosity of the siloxane phase making it closer to the viscosity of the polymer phase and resulting in an improved overall dispersion. There may also be some cross-linking of the siloxane with the silica to form a cross-linked rubber, which will increase the ductility and impact resistance of the copolymer.

In one embodiment, the silica is a finely divided filler derived from fumed, precipitated or mined forms of silica. The fillers are typically characterized by surface areas greater than about 50 m²/g and up to about 900 m²/g. In one embodiment, the surface area of the silica is from about 50 to about 400 m²/g.

The silica filler may be treated with filler treating agents. Filler treating agents are liquid organosilicon compounds containing silanol groups or hydrolysable precursors of silanol groups. Some examples of filler treating agents include low molecular weight liquid hydroxyl- or alkoxy-terminated polydiorganolsiloxanes and hexaorganolsilazanes. The silicon-bonded hydrocarbon radicals in all or a portion of the filler treating agent can contain substituents such as carbon-carbon double bonds. In one embodiment, the filler treating agent is an oligomeric hydroxyl-terminated polydimethylsiloxane having an average degree of polymerization of about 2 to about 100. In another embodiment, the oligomeric hydroxyl-terminated polydimethylsiloxane has a degree of polymerization of about 2 to about 10.

The filler treating agent may be used in any amount to react with the silica filler. In one embodiment, the silica filler is reacted with a filler treating agent in an amount of from about 10 to about 45 percent by weight based on the weight of the silica filler.

The silica filler may be treated at a temperature greater than 100° C. and up to about 200° C.

In one embodiment, the reinforced filler is a D4 cyclic polyorganosiloxane treated fumed silica.

The filler may be used in a ratio of filler to hydroxyaromatic terminated siloxane reagent ranging from about 0.3:1 to about 2:1. In one embodiment, the ratio of filler to hydroxyaromatic terminated siloxane reagent ranges from about 0.3:1 to less than about 2:1. In another embodiment, the ratio of filler to hydroxyaromatic terminated siloxane reagent is from about 0.3 to about 1.5:1. In another embodiment, the ratio of filler to hydroxyaromatic terminated siloxane reagent is from about 0.75:1 to about 1.5:1. In another embodiment, the ratio of filler to hydroxyaromatic terminated siloxane reagent is from about 0.8:1 to about 1.25:1. In another embodiment, the ratio of filler to hydroxyaromatic terminated siloxane reagent is from about 0.9:1 to about 1.2:1. In another embodiment, the ratio of filler to hydroxyaromatic terminated siloxane reagent is about 1:1.

The combined amount of filler and hydroxaromatic terminated siloxane reagent is present in an amount up to about 20 percent by weight based on the weight of the mixture. In one embodiment, the combined amount of filler and hydroxyaromatic terminated siloxane reagent is present in an amount of from about 0.1 to about 20 percent by weight based on the weight of the composition. In another embodiment, the combined amount of filler and hydroxyaromatic terminated siloxane reagent is present in an amount of from about 1 to about 10 percent by weight based on the weight of the composition.

The processing aid may be mixed with the reactants in any conventional manner and in any order. In one embodiment, reactants and processing aid are added to the feedthroat of an extruder. The processing aid may be premixed with the hydroxyaromatic terminated siloxane reagent before blending with the polyarylene ether and peroxide. The premix of hydroxyaromatic terminated siloxane reagent and processing aid may be fed to the feedthroat of an extruder in a feedstream and the polyarylene ether and oxidant may be fed to the feedthroat in separate feedstreams.

The filler may be mixed with the reactants in any conventional manner and in any order with the proviso that the filler should be added simultaneously with the oxidant or added before the oxidant. In one embodiment, reactants and filler are added to the feedthroat of an extruder. The filler may be premixed with the hydroxyaromatic terminated siloxane reagent before blending with the polyarylene ether and peroxide. The premix of hydroxyaromatic terminated siloxane reagent and filler may be fed to the feedthroat of an extruder in a feedstream and the polyarylene ether and oxidant may be fed to the feedthroat in separate feedstreams.

In another embodiment, the polyarylene ether, hydroxyaromatic terminated siloxane reagent and filler or processing aid is fed to the throat of an extruder while the oxidant is fed to the extruder downstream from the feedthroat of the extruder. In another embodiment, the polyarylene ether and fumed silica are added to the feedthroat of an extruder and a mixture of the hydroxyaromatic terminated siloxane reagent and oxidant are added downstream in the extruder.

The oxidant may be added to the extruder simultaneously or after the hydroxyaromatic terminated siloxane reagent, but should not be added to the extruder before the hydroxyaromatic terminated siloxane reagent, as the oxidant may break down and decompose before the hydroxyaromatic terminated siloxane reagent can reactant with the polyarylene ether and oxidant to form the copolymer.

In another embodiment, the polyarylene ether, hydroxyaromatic terminated siloxane reagent and filler are compounded in an extruder. The extrudate is compounded in a second compounding step with the oxidant to produce the copolymer.

In one embodiment, polyphenylene oxide, eugenol-terminated siloxane reagent, fumed silica and peroxide are added to the feedthroat of an extruder. In another embodiment, the fumed silica and eugenol-terminated siloxane reagent are premixed. The premix is blended with polyphenylene oxide and peroxide and the blend is added to the feedthroat of an extruder. In another embodiment, the premix of fumed silica and eugenol-terminated siloxane reagent is fed to the feedthroat of an extruder in one feedstream, the polyphenylene oxide is fed to the feedthroat of the extruder in a separate feedstream and the peroxide is fed to the feedthroat in another separate feedstream.

In another embodiment, polyphenylene oxide, eugenol-terminated siloxane reagent and fumed silica are added to the feedthroat of an extruder and peroxide is added downstream in the extruder. In another embodiment, polyphenylene oxide and fumed silica are added to the feedthroat of an extruder and a liquid mixture of eugenol-terminated siloxane reagent and peroxide are added downstream in the extruder.

A premix of fumed silica and eugenol-terminated siloxane is blended with polyphenylene oxide and peroxide and the blend is added to the feedthroat of an extruder. In another embodiment, the premix of fumed silica and eugenol-terminated siloxane reagent is fed to the feedthroat of an extruder in one feedstream, the polyphenylene oxide is fed to the feedthroat of the extruder in a separate feedstream and the peroxide is fed to the feedthroat in another separate feedstream.

In another embodiment, polyphenylene oxide, eugenol-terminated siloxane and fumed silica are compounded in an extruder and extruded into pellets. The pellets are compounded in a second compounding step with peroxide to produce the copolymer.

In one embodiment, a composition comprises a polyarylene ether, a hydroxyaromatic terminated siloxane reagent, oxidant and filler. The polyarylene ether, hydroxyaromatic terminated siloxane reagent, oxidant and filler are as described above. In one embodiment, the composition comprises a polyphenylene ether, a eugenol capped siloxane, fumed silica and an oxidant.

Other additives may be included, such as flame retardants, impact modifiers, endothermic flame retardants, intumescent materials, structural fillers, such as glass, talc, clay, carbon fiber, milled glass, quartz, wollastonite; low melting temperature glass, colorants, low smoke additives, such as borate salts, melamine borate, phosphates and low-melting glass, impact modifiers, silicone gum vinyl, supported platinum catalyst, boric acid, amino siloxane fluid and end-capping agents, such as salicylate capping compounds.

The polyarylene ether copolymer may be molded. In one embodiment, the polyarylene ether copolymer is injection molded. Polyarylene ether copolymers having over 3 percent by weight of hydroxyaromatic terminated siloxane reagent may need a filler or processing aid to improve the processing conditions of the copolymer for suitable moldability.

Any suitable molding equipment may be used for molding the copolymers. In one embodiment, the molding machine used is an injection molding machine. The melt temperature for molding was in a range of from about 230° C. to about 350° C. The mold temperatures may be in a range of from about 50° C. to about 150° C.

In one embodiment, the composition comprises from about 86 to about 93.3 percent by weight polyphenylene ether, from about 3 to about 6 percent by weight eugenol end-capped siloxane reagent, from about 3 to about 6 percent by weight fumed silica, from about 0.7 to about 2 percent by weight peroxide and the ratio of fumed silica to eugenol end-capped siloxane reagent is 1:1, wherein the percent by weights are based on the weight of the composition.

In another embodiment, the composition comprises about 90.25 percent by weight polyphenylene ether, about 4.5 percent by weight eugenol end-capped siloxane reagent, about 4.5 percent by weight fumed silica and about 0.75 percent by weight peroxide, wherein the percent by weights are based on the weight of the composition.

In another embodiment, articles may be prepared by extruding or injection molding mixtures comprising polyarylene ether, hydroxyaromatic terminated siloxane reagents, oxidants, optionally, filler and optionally, a processing aid. The article may be a film. In one embodiment, the article is a film having a thickness of about 2 to about 30 mils.

In order that those skilled in the art will be better able to practice the present disclosure, the following examples are given by way of illustration and not by way of limitation.

### EXAMPLES

### Details of Experimental:

Extruder 1: ZSK 25 Twin-screw Extruder with a 10 barrel set-up ZSK-25 mega compounder (bilobed, L/D=25.52)

Extruder 2: 30 mm twin-screw extruder (E-1 with T30-33 screw, L/D of 32/1, 10 barrels)

Extruder Temperature=Max. 350° C.

PPO=Poly-2,6-dimethylphenylene ether (PPO 800), 0.46 intrinsic viscosity as measured in chloroform at 25° C.

Eu—Si=Eugenol Capped Siloxane (D₄₅), supplied by GE Silicones, grade CF2003

BPO=Benzoyl Peroxide

DCP=Dicumyl Peroxide

Luperox®101XL=1,1,4,4-tetramethyltetramethylene bis(tert-butyl peroxide)

Ciba® Irgaphos®=Tris(2,4-di-tert-butylphenyl)phosphate

Ciba® Irganox® 168=Tris(2,4-di-t-butylphenyl)phosphate)

Cyclic siloxane D4 treated fumed silica, GE Silicones

Glass 1=Chopped glass fiber having an average diameter of 14 μm with an average length of 4 mm (Owens Corning® Y122)

Magshield® UF=Magnesium hydroxide

All materials were preblended in a Hentschel type mixer.

### Details of Testing:

¹H nuclear magnetic resonance (NMR) measurements were performed on a Bruker AV 300 MHz spectrometer, using CDCl₃ as solvent.

Gel permeation chromatograph (GPC) measurements were performed with a Shimadzu instrument, using dicloromethane as the eluent.

Notched izod impact testing was done at room temperature in accordance with ISO-180 method on a Ceast instrument with 5.5 J hammer, keeping the gate end downward. Ten bars of a sample were tested and the average values are reported in KJ/m².

The tensile tests were done on an Instron Universal Testing Machine (Model No. 5566, motor driven test frame) as per ISO 527 test method. In the tensile tests, the extensometer was attached to the specimen until 1% of tensile strain, with the crosshead speed of 1 mm/min. The extensometer was then removed and the cross-head speed was maintained at 50 mm/min.

The flammability of the compositions was tested as per UL94 flame testing procedure. Tests were conducted in an Atlas HVUL cabinet (HVUL-14095 & 14111) with provision to remove combustion products after each test. Flame was applied using a Tirril burner that has a tube of length of 100 mm and inside diameter of 9 mm (in compliance with ASTM D5025) by controlled flow of methane gas. All the tests were conducted in an environment of 23±2° C. and 50±5% RH. The samples were conditioned at 23° C. and 50% humidity for 48 hrs prior to testing. The flammability was tested with bars of 1.6 mm thickness. 10 or 20 flame bars were tested and the average value reported as average flameout time (FOT) in seconds. The rating criteria, as per UL-94 standard are reproduced below for reference:

V0 (vertical burn): burning stops within 10 seconds after two applications of ten seconds each of a flame to a test bar; no flaming drips are allowed.

V1 (vertical burn): burning stops within 30 seconds after two applications of ten seconds each of a flame to a test bar; no flaming drips are allowed.

V2 (vertical burn): burning stops within 30 seconds after two applications of ten seconds each of a flame to a test bar; flaming drips are allowed.

The flame-out times were also analyzed using a design for six sigma (DFSS) tool which calculates probability of first time pass (p(ftp)). The p(ftp) value provides a quantitative estimate of the probability of a material passing either V0 or V1 rating.

UL94 Vertical flame testing (5V-B and 5V-A) was done on a specimen. A bar specimen was supported in a vertical position and a flame was applied to one of the lower corners of the specimen at a 20° angle. The flame was applied for 5 seconds and was removed for 5 seconds. The flame application and removal was repeated five times. A plaque specimen was mounted in a horizontal position and a flame was applied to the center of the lower surface of the plaque. The flame was applied for 5 seconds and was removed for 5 seconds. The flame application and removal was repeated five times. The rating criteria, as per UL-94 standard are reproduced below for reference:

5V-B: specimens must not have any flaming or glowing combustion for more than 60 seconds after the five flame applications; specimens must not drip flaming particles that ignite cotton; plaque specimens must not exhibit burnthrough (a hole).

5V-A: specimens must not have any flaming or glowing combustion for more than 60 seconds after the five flame applications; specimens must not drip; specimens must not be destroyed in the area of the flame.

### Comparative Example 1

60 g of PPO was dissolved in 120 ml anhydrous toluene in a three-necked round bottom flask equipped with a stir bar, a condenser and a nitrogen inlet. 40 g of Eu—Si (liquid) was added drop-wise to the PPO solution under vigorous stirring at room temperature. The reaction temperature was subsequently raised to 80-90° C. and 1 g of BPO dissolved in 10 ml of toluene was added to the reaction mixture over a period of 1 hour. The reaction was continued for another 7 hours. The homogenous solution obtained was precipitated in 2000 ml of methanol with vigorous stirring. The white powdery solid obtained was dried overnight under vacuum at 80° C. The yield of the free flowing powder solid product was 89 g (87%).

### Example 2

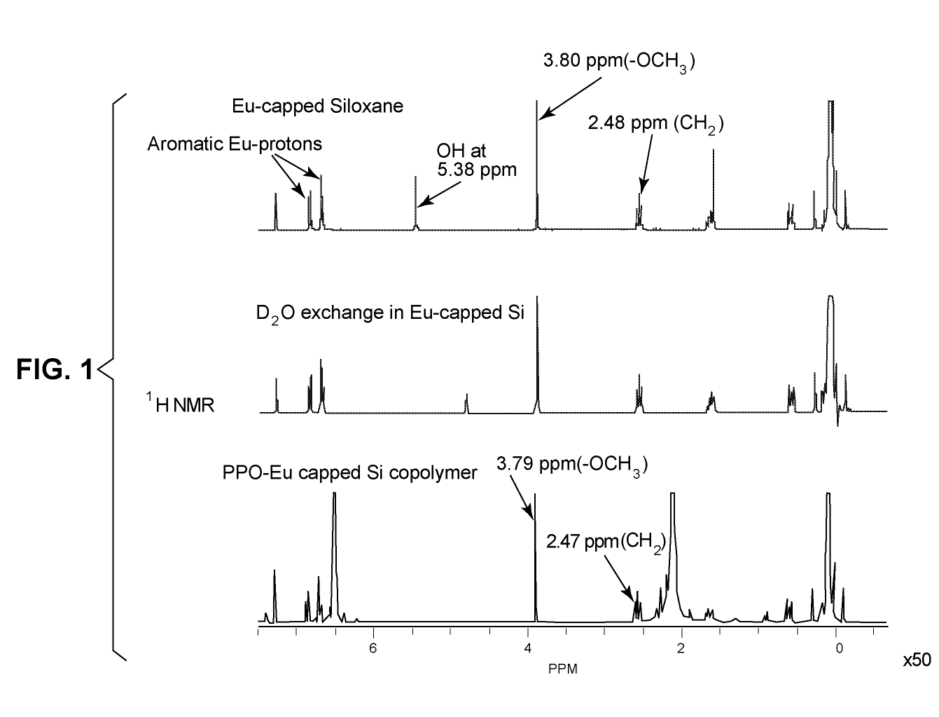

10 wt % Eu—Si, 1 wt % DCP and PPO in a feed ratio PPO to Eu—Si of 90/10 were added to a high-speed mixer and thoroughly mixed at room temperature to ensure homogeneity. All the components were fed upstream to Extruder 1 using a single vibratory feeder. An atmospheric vent was provided in the sixth barrel and a vacuum equivalent to 200 mbar was applied at the ninth barrel. The throughput was maintained at 7 kg per hour at 300 rpm. The temperature profile employed is shown in Table-1. The reaction time in the extruder was less than 1 minute. Extruded pellets were obtained and dried for 4 hrs at 75° C. Copolymer formation was confirmed by NMR analysis shown in FIG. 1. In FIG. 1, the NMR scan for the copolymer shows the disappearance of the eugenol-OH peak at 5.38 ppm indicating copolymer formation.

TABLE 1
Temperature profile (° C.)

| | |
|---|---|
| Barrel 1 | 100 |
| Barrel 2 | 220 |
| Barrel 3 | 230 |
| Barrel 4 | 250 |
| Barrel 5 | 250 |
| Barrel 6 | 260 |
| Barrel 7 | 260 |
| Barrel 8 | 270 |
| Barrel 9 | 270 |
| Barrel 10 | 280 |
| Die | 285 |

### Example 3

The GPC data for Comparative Example 1 and Example 2 are shown in Table 2. The PPO-Siloxane copolymer prepared by solution results in a lower molecular weight than the molecular weight of the starting PPO. The PPO-Siloxane copolymer has a slightly higher molecular weight in comparison to PPO, which is possibly due to the end grafting of Eu—Si onto the PPO chains. Table 2 shows that the molecular weight does not diminish, but remains comparable to the starting materials.

TABLE 2
GPC data for PPO, Eu—Si and PPO-Siloxane copolymers
with 10 wt % siloxane

| | Mn | | D |
|---|---|---|---|
| Sample Name | (avg value) | Mw (avg value) | (avg. value) |
| PPO | 20,373 | 45,853 | 2.25 |
| PPO-Siloxane copolymer | 12,417 | 31,870 | 2.57 |
| Comparative Example 1 | | | |
| PPO-Siloxane copolymer | 21,627 | 56,139 | 2.60 |
| Example 2 | | | |
| Eu—Si | 2087 | 4459 | 2.14 |

### Example 4

PPO-Siloxane copolymers were prepared in accordance with Example 2 except that the amounts for the reactants shown in Table 3 were used. The Ciba® Irganox® and Ciba® Irgaphos® additives were mixed with the other reactants in the high speed mixer.

The extruded pellets were molded into samples for PPO—Si-1 and PPO—Si-2. The molding was carried out on a 60T L&T DEMAG injection molding machine. The barrel zones were electrically heated and maintained between 265-280° C. and the screw speed was set at 100 rpm. The mold was maintained at 70° C. with the help of an oil heated mold temperature controller. The property profiles for samples PPO—Si-1 and PPO—Si-2 are shown in Table 3.

The control sample was PPO and was extruded and molded under similar conditions as samples PPO—Si-1 and PPO—Si-2 except that the control PPO was prepared without Eu—Si or DCP.

TABLE 3
Mechanical and Flame Retardant Properties of PPO-Siloxane Copolymers

| | Control 1 | PPO-Si-1 | PPO-Si-2 |
|---|---|---|---|
| Components | | | |
| PPO | 99.5 | 97.5 | 96.5 |
| Eu—Si | 0 | 1 | 2 |
| DCP | 0 | 1 | 1 |
| Ciba ® Irganox ® | 0.3 | 0.3 | 0.3 |
| 1010 | | | |
| Irg 168 | 0.2 | 0.2 | 0.2 |
| Total | 100 | 100 | 100 |
| Properties | | | |
| E-Modulus (Mpa) | 2297.8 | 2228.8 | 2169 |
| Stress at Yield | 75.7 | 75.1 | 74.3 |
| (Mpa) | | | |
| Strain at Yield (%) | 5.9 | 5.8 | 5.7 |
| Stress at Break | 56.9 | 61.7 | 59.3 |
| (Mpa) | | | |
| NI (kJ/m²) | 3.1 | 4.4 | 4.5 |
| Average FOT (s) | 12.4 | 2.8 | 2.5 |
| p(ftp) for VO | 0.03 | 1 | 1 |
| p(ftp) for V1 | 0.97 | 1 | 1 |

Table 3 shows that the copolymers have a slightly higher room temperature notched impact strength and an improved flame retardant performance over polyphenylene ether and have comparable mechanical properties to polyphenylene ether.

### Example 5

PPO-Siloxane copolymer samples PPO—Si-1 and PPO—Si-2 were prepared as in Example 4. PPO-Siloxane copolymer samples PPO—Si-3, PPO—Si-4 and PPO—Si-5 were prepared in accordance with Example 2 except that the amounts shown in Table 4 and Extruder 2 were used. The Ciba® Irganox® and Ciba® Irgaphos® additives and RDP processing aid were mixed with the other reactants in the high speed mixer before adding to the extruder.

The extruded pellets were molded into samples for all of the PPO-Siloxane copolymer samples shown in Table 4. The molding was carried out on a 60T L&T DEMAG injection molding machine. The barrel zones were electrically heated and maintained between 265-280° C. and the screw speed was set at 100 rpm. The mold was maintained at 70° C. with the help of an oil heated mold temperature controller. The moldability for the PPO-Siloxane copolymer samples is shown in Table 4.

TABLE 4
PPO-Siloxane copolymer Moldability Results

| Components | PPO-Si-1 | PPO-Si-2 | PPO-Si-3 | PPO-Si-4 | PPO-Si-5 |
|---|---|---|---|---|---|
| PPO | 97.5 | 96.5 | 93.5 | 88.5 | 83.5 |
| Eu—Si | 1 | 2 | 5 | 5 | 5 |
| DCP | 1 | 1 | 1 | 1 | 1 |
| Ciba ® | 0.3 | 0.3 | 0.3 | 0.3 | 0.3 |
| Irganox ® | | | | | |
| 1010 | | | | | |
| Irgaphos 168 | 0.2 | 0.2 | 0.2 | 0.2 | 0.2 |
| RDP | | | | 5 | 10 |
| Total | 100 | 100 | 100 | 100 | 100 |
| Moldability | Good | Good | Poor | Good | Good |

Moldability is an indication of the processability of the copolymer. Moldability of the polyarylene ether copolymer with lower amounts of Eu—Si is good. When a processing aid is added to a copolymer with a high amount of Eu—Si, the moldability was good.

### Example 6

PPO-Siloxane copolymer samples PPO—Si-6, PPO—Si-7 and PPO—Si-8 were prepared in accordance with Example 2 except that the amounts shown in Table 5 for the reactants were used and Extruder 2 was used. The fumed silica filler was mixed with the other reactants in the high speed mixer before adding to the Extruder 2.

The extruded pellets were molded into samples for all of the PPO-Siloxane copolymer samples shown in Table 5. The molding was carried out on a 60T L&T DEMAG injection molding machine. The barrel zones were electrically heated and maintained between 265-280° C. and the screw speed was set at 100 rpm. The mold was maintained at 70° C. with the help of an oil heated mold temperature controller. The moldability for the PPO-Siloxane copolymer samples shown in Table 5.

TABLE 5
PPO-Siloxane copolymer Moldability Results

| Components | PPO-Si-6 | PPO-Si-7 | PPO-Si-8 | PPO-Si-9 |
|---|---|---|---|---|
| PPO | 89 | 79 | 84 | 84 |
| Eu—Si | 5 | 10 | 5 | 10 |
| DCP | 1 | 1 | 1 | 1 |
| Fumed Silica | 5 | 10 | 10 | 5 |
| Total | 100 | 100 | 100 | 100 |
| Moldability | Good | Good | Good | Fair |

### Example 7

A control sample 2 was prepared in accordance with control sample 1 in Example 4. The amounts and data are shown in Table 6.

Samples 10 to 14 were prepared in accordance with Example 6. The amounts and data are shown in Table 6.

TABLE 6
PPO-Siloxane Copolymers with Fumed Silica

| | | Sample | | | | | |
|---|---|---|---|---|---|---|---|
| | — | Control 2 | 10 | 11 | 12 | 13 | 14 |
| 0.46 IV PPO | | 99 | 90.25 | 89 | 83.75 | 79 | 75 |
| Eugenol Siloxane (CF2003) | | | 4.5 | 5 | 6 | 10 | 12 |
| DCP | | 1 | 0.75 | 1 | 1 | 1 | 1 |
| Fumed Silica | | | 4.5 | 5 | 6 | 10 | 12 |
| Ratio of Silica:Siloxane | | — | 1 | 1 | 1 | 1 | 1 |
| Siloxane + FS | | — | 9 | 10 | 12 | 20 | 24 |
| — | | | | | | | |
| Tactile Feel | | normal | normal | normal | normal | normal | slip |
| General | | tough | tough | tough | tough | tough | delam |
| Appearance [0–5], [Good–Bad] | | 1 | 0 | 1 | 0 | 1 | 5 |
| Flexural Modulus-Avg/0 | MPa | 2760 | 2340 | 2382 | 2230 | 2023 | 1990 |
| Flexural Strength-Avg/0 | MPa | 115 | 94.9 | 102 | 90.2 | 84 | 78 |
| Stress@Break-Avg/0 | MPa | 60 | 57.2 | 57.71 | 53.6 | 49.2 | 46 |
| Strain@Break-Avg/0 | % | | 71 | 8.42 | 63 | 10.98 | |
| UL94 FOT 1 | s | 5 | | 2.2 | | 3.2 | |
| UL94 FOT 2 | s | 12 | | 3.6 | | 7.6 | |
| Result @ 3.2 mm | | V-1 | V-0 | V-0 | V-0 | V-0 | Fail |

The results in Table 6 show that the reinforced PPO-Siloxane copolymer has improved flame retardant properties and that the samples having a combined amount of filler and hydroxyaromatic terminated siloxane reagent up to 20 percent by weight have good moldability.

### Example 8

As shown in Example 7, a combined amount of filler and hydroxyaromatic terminated siloxane up to about 20 percent by weight based has good flame retardant properties and good moldability. This example demonstrates the superior flame retardant properties of an exemplary composition, sample 15, which has a combined amount of filler and hydroxyaromatic terminated siloxane of less than 10 percent by weight.

Samples 15 and 16 were prepared in accordance with Example 6. The amounts and data are shown in Table 7.

TABLE 7

| Sample | | 15 | 16 |
|---|---|---|---|
| PPO 0.46IV | | 90.25 | 83.75 |
| CF2003 | | 4.5 | 7.5 |
| Untreated Fumed Silica | | 4.5 | 7.5 |
| Luperox 101XL | | 0.75 | 1.25 |
| Boric Acid MB | | | |
| G1100 | | | |
| RDP | | | |
| | TOTAL | 100 | 100 |
| Cond/Res | Units | 1295778 | 1295781 |
| Flexural Modulus-Avg/0 | MPa | 2330 | 2240 |
| Deflection temp-Avg/0 (0.455 MPa) | ° C. | 202 | 199 |
| Deflection temp-Avg/0 (1.82 MPa) | ° C. | 183 | 181 |
| Impact Strength-Avg/0 (N, 23° C.) | J/m | 117.53 | 165.05 |
| Impact Strength-Std/0 (N, 23° C.) | — | 10.16 | 15.67 |
| Impact Strength-Avg/0 (N, −30° C.) | J/m | 83.71 | 123.21 |
| Impact Strength-Std/0 (N, −30° C.) | — | 9.56 | 17.49 |
| Impact Strength-Avg/0 (U, 23° C.) | J/m | 0 | 827.21 |
| Energy, Total-Avg/0 (23° C.) | J | 45 | 28.1 |
| Energy, Total-Avg/0 (−30° C.) | J | 31.1 | 19.3 |
| Stress at Yield-Avg/0 | MPa | 65.3 | 58.1 |
| Stress at Break-Avg/0 | MPa | 56.6 | 51.9 |
| Elongation at Yield-Avg/0 | % | 6 | 5.9 |
| Elongation at Break-Avg/0 | % | 58 | 23 |
| MFR-Avg/0 (310° C., 10 kg) | g/10 min | 5.16 | 2.83 |
| Average FOT (3.2 mm) | (sec) | 1.4 | 11.6 |
| Average FOT (3.2 mm) | (sec) | 0.70 | 15.23 |
| Average FOT (1.5 mm) | (sec) | 2.4 | 12.7 |
| Average FOT (1.5 mm) | (sec) | 1.35 | 11.38 |

The flame retardant testing for Examples 15 and 16 shows excellent flame retardant properties for both samples. The flame retardant properties for sample 15 show a superior performance.

### Example 9

Filler added to a composition comprising a polyarylene ether and a hydroxyaromatic terminated siloxane improves one or more properties of the composition, such as impact strength, flame retardant properties and moldability. Samples 17-25 were prepared in accordance with Example 6. The amounts and data are shown in Tables 8 and 9.

TABLE 8

| COMPONENT | Units | 17 | 18 | 19 | 20 | 21 |
|---|---|---|---|---|---|---|
| 0.46 IV PPO | | 90.25 | 90 | 81 | 81 | 79 |
| Eugenol Siloxane (CF2003) | | 4.5 | 6 | 6 | 12 | 10 |
| DCP | | 0.75 | 1 | 1 | 1 | 1 |
| Fumed Silica | | 4.5 | 3 | 12 | 6 | 10 |
| Ration Silica:Siloxane | | 1 | 0.5 | 2 | 0.5 | 1 |
| Siloxane + FS | | 9 | 9 | 18 | 18 | 20 |
| Tactile Feel | | normal | slip | normal | slip | normal |
| General | | tough | tough | tough | delam | tough |
| Appearance [0–5], [Good–Bad] | | 0 | 2 | 2 | 5 | 1 |
| Flexural Modulus-Avg/0 | MPa | 2340 | 2380 | 2430 | 1940 | 2023 |
| Flexural Strength-Avg/0 | MPa | 94.9 | 97 | 94 | 72 | 84 |
| Stress @ Break-Avg/0 | MPa | 57.2 | 63 | 55 | 46 | 49.2 |
| Strain @ Break-Avg/0 | % | 71 | | | | 10.98 |
| Result @ 3.2 mm | | V-0 | V-1 | V-1 | V-1 | V-0 |

TABLE 9

| Component | 22 | 23 | 24 | 25 |
|---|---|---|---|---|
| 0.46 IV PPO | 94 | 92.5 | 89 | 79 |
| Eugenol Siloxane (CF 2003) | 5 | 5 | 5 | 10 |
| DCP | 1 | 1 | 1 | 1 |
| D4 Treated Fumed Silica | | 1.5 | 5 | 10 |
| Tactile Feel | Slip | Normal | Normal | Normal |
| General | Delam | Tough | Tough | Tough |
| Appearance (0–5), (Good–Bad) | 4 | 1 | 1 | 1 |
| Flexural Modulus-Avg/0 (Mpa) | 2299 | 2403 | 2382 | 2023 |
| Flexural Strength-Avg/0 (Mpa) | 93 | 107 | 102 | 84 |
| Impact Strength-Avg/0 @ | 5.38 | 6.74 | 8.96 | 14.68 |
| 23° C. 2.75 J (kJ/m²) | | | | |
| Impact Strength-Avg/0 @ | 4.81 | 5.78 | 7.46 | 10.56 |
| 30° C. 2.75 J (kJ/m²) | | | | |
| Stress @ Break-Avg/0 (Mpa) | 58.74 | 64.42 | 57.71 | 49.2 |
| Strain @ Break-Avg/0 (%) | 3.56 | 8.13 | 8.42 | 10.98 |
| UL94 FOT 1 (s) | 3 | 3.8 | 2.2 | 3.2 |
| UL94 FOT 2 (s) | 3.8 | 5.4 | 3.6 | 7.6 |
| Result @ 3.2 mm | V-0 | V-0 | V-0 | V-0 |

Compositions having a 1:1 ratio of filler to siloxane show a superior balance of properties flame retardancy, moldability and impact strength.

### Example 10

This example demonstrates the superior flame retardant properties of an exemplary composition, sample 15, having a combined amount of filler and hydroxyaromatic terminated siloxane having less than 10 percent by weight. The 5V and 5VA tests are very stringent flame retardancy test and are much more difficult to pass than the UL94 V0 flame test.

Samples 15 and 16 were prepared in accordance with Example 6. The amounts and data are shown in Table 10.

TABLE 10
COMPONENTS

| | 15 | 16 |
|---|---|---|
| PPO 0.46IV | 90.25 | 83.75 |
| CF2003 | 4.5 | 7.5 |
| Untreated Fumed Silica | 4.5 | 7.5 |
| Luperox 101XL | 0.75 | 1.25 |

SMOKE

| | | | |
|---|---|---|---|
| Ds, max (1.5 mm) | ASTM E662 | 84 | 131 |
| Ds, max (3.2 mm) | ASTM E662 | 163 | 220 |

FLAME

| | | | | |
|---|---|---|---|---|
| UL94 5VB @ 2 mm | UL94 | | Pass | Fail |
| UL94 5VA @ 2 mm | UL94 | | Pass | Fail |
| UL94 5VB @ 1.5 mm | UL94 | | Pass | Fail |
| UL94 5VA @ 1.5 mm | UL94 | | Pass | Fail |
| UL94 5VB @1.0 mm | UL94 | | Pass | Fail |
| UL94 5VA @1.0 mm | UL94 | | Pass | Fail |
| LOI | ISO 4589 | % | 31.4 | 29.4 |

Electricals

| | | | | |
|---|---|---|---|---|
| GWIT (@ 1 mm) | IEC 60695-2-14 | ° C. | 825 | 800 |
| GWFI (@ 1 mm) | IEC 60695-2-12 | ° C. | 960 | 825 |
| CTI | UL 746 | V | 150 (4) | 150 (4) |
| Dielectric Strength (1.5 mm) | ASTM D 149/IEC60243 | kV/mm | 29.6 | 30.9 |
| Dielectric Constant @ 50 Hz | IEC250//ASTM D 150 | | 2.647 | 2.664 |
| Dissipation factor @ 50 Hz | IEC 250/ASTM D 150 | | 0.0262 | 0.0287 |
| Dielectric Constant @ 1 MHz | IEC250//ASTM D 150 | | 2.698 | 2.733 |
| Dissipation factor @ 1 MHz | IEC 250/ASTM D 150 | | 0.0015 | 0.0019 |

Misc

| | | | | |
|---|---|---|---|---|
| Ball Pressure - Passed @ | IEC 60695-10-2 | ° C. | 125 | 125 |
| Thermal Conductivity @65° C. | ASTM E 1530 | W/m°K | 0.221 | 0.220 |

Sample 15 demonstrates superior flame retardant properties.

### Example 11

Exemplary samples 15 and 16 demonstrate improved smoke data (lower Ds numbers) over a PPO control sample 3. Samples 15 and 16 and Control 3 were prepared in accordance with Example 6. The data is shown in Table 11.

TABLE 11

| | | Control 3 | 15 | 16 |
|---|---|---|---|---|
| Smoke Density @ 1.5 mm | | | | |
| Ds (1.4 min) | ASTM E662 | | 2 | 19 |
| Ds (4 min) | ASTM E662 | 167 | 8 | 91 |
| Ds, max | ASTM E662 | 183 | 84 | 131 |
| Time to Ds, max | ASTM E662 | 8.4 | 19 | 13 |
| Ds (20 min) | ASTM E662 | | 84 | 128 |
| Stdev-Ds (1.4 min) | ASTM E662 | | 2 | 11 |
| Stdev-Ds (4 min) | ASTM E662 | 20.1 | 2 | 38 |
| Stdev-Ds, max | ASTM E662 | 32.2 | 27 | 36 |
| Stdev-Time to Ds, max | ASTM E662 | 3.3 | 0 | 3 |
| Stdev-Ds (20 min) | ASTM E662 | | 26 | 31 |
| Smoke Density @ 3.2 mm | | | | |
| Ds (1.4 min) | ASTM E662 | | 0 | 11 |
| Ds (4 min) | ASTM E662 | 292 | 47 | 167 |
| Ds, max | ASTM E662 | 388 | 163 | 220 |
| Time to Ds, max | ASTM E662 | 8.8 | 18 | 11 |
| Ds (20 min) | ASTM E662 | 304 | 168 | 233 |
| Stdev-Ds (1.4 min) | ASTM E662 | | 1 | 8 |
| Stdev-Ds (4 min) | ASTM E662 | 25 | 15 | 31 |
| Stdev-Ds, max | ASTM E662 | 28 | 44 | 21 |
| Stdev-Time to Ds, max | ASTM E662 | 0.6 | 1 | 2 |
| Stdev-Ds (20 min) | ASTM E662 | 20 | 43 | 16 |

### Example 12

Samples 26-28 demonstrate that good flame retardant properties are maintained when an additive or reinforced filler is added to the composition. Samples 26-28 are prepared in accordance with Example 6. Amounts and data are shown in Table 12.

TABLE 12

| Item Description | | 15 | 26 | 27 | 28 |
|---|---|---|---|---|---|
| PPO 0.46IV | | 90.25 | 90.25 | 90.25 | 90.25 |
| CF2003 | | 4.5 | 4.5 | 4.5 | 4.5 |
| Untreated Fumed Silica | | 4.5 | 4.5 | 4.5 | 4.5 |
| Luperox 101XL | | 0.75 | 0.75 | 0.75 | 0.75 |
| Glass 1 | | | 10 | 25 | 43 |
| % Glass | | | 10 | 20 | 30 |
| Density | — | 1.0979 | 1.1766 | 1.2623 | 1.3573 |
| Flexural Modulus-Avg | MPa | 2450 | 3870 | 6170 | 8300 |
| Flexural Modulus-Std | — | 70.8 | 55.2 | 203 | 381 |
| Flex Stress @ 5% Strain-Avg | MPa | 99.2 | 134 | | |
| Flex Stress @ 5% Strain-Std | — | 2.22 | 2.17 | | |
| HDT (1.82 MPa, 3.2 mm)-Avg | ° C. | 180 | 200 | 202 | 202 |
| HDT (1.82 MPa, 3.2 mm)-Std | — | 1.05 | 0.611 | 0.0577 | 1.35 |
| Izod Impact Strength (N, 23° C.)-Avg | J/m | 122 | 77.6 | 96.9 | 105 |
| Izod Impact Strength (N, 23° C.)-Std | — | 14.1 | 1.8 | 5.16 | 3.26 |
| Cnd: Speed | mm/min | 5 | 5 | 5 | 5 |
| Modulus of Elasticity-Avg | MPa | 2100 | 3990 | 6760 | 9898 |
| Modulus of Elasticity-Std | — | 64.42 | 190.919 | 171.756 | 815.15 |
| Stress at Yield-Avg | MPa | 62.2 | 79.4 | 100 | 118 |
| Stress at Yield-Std | — | 0.122 | 0.335 | 0.447 | 0.548 |
| Stress at Break-Avg | MPa | 54.1 | 78 | 100 | 118 |
| Stress at Break-Std | — | 1.49 | 0.828 | 0.447 | 0.548 |
| Elongation at Yield-Avg | % | 5.4 | 3.3 | 2.6 | 2.2 |
| Elongation at Yield-Std | — | 0.089 | 0.055 | 0 | 0.055 |
| MVR (300° C., 10 Kg)-Avg | cc/10 min | 3.41 | 1.911 | 1.025 | 0.962 |
| MVR (300° C., 10 Kg)-Std | — | 0.01018 | 0.0623 | 0.0232 | 0.122 |
| MFR (300° C., 10 Kg)-Avg | g/10 min | 3.73 | 2.21 | 1.27 | 1.28 |
| MFR (300° C., 10 Kg)-Std | — | 0.01 | 0.07 | 0.03 | 0.16 |
| UL94 V-0 | 3.2 mm | 15 | 26 | 27 | 28 |
| FOT1 | sec | 1.3 | 1.1 | 1.0 | 1.2 |
| FOT2 | sec | 2.3 | 2.9 | 2.9 | 3.6 |
| FOT | sec | 1.8 | 2.0 | 1.9 | 2.4 |
| FOT-STD | sec | 1.2 | 1.1 | 1.4 | 1.8 |
| p (V-1) | | 1.000 | 1.000 | 1.000 | 1.000 |
| p (V-0) | | 1.000 | 1.000 | 1.000 | 0.993 |
| Rating | | V-0 | V-0 | V-0 | V-0 |
| UL94 V-0 | 1.5 mm | 15 | 26 | 27 | 28 |
| FOT1 | sec | 1.9 | 1.8 | 2.0 | 2.0 |
| FOT2 | sec | 3.3 | 4.0 | 3.9 | 5.8 |
| FOT | sec | 2.6 | 2.9 | 3.0 | 3.9 |
| FOT-STD | sec | 1.7 | 1.6 | 1.5 | 2.7 |
| p (V-1) | | 1.000 | 1.000 | 1.000 | 1.000 |
| p (V-0) | | 0.992 | 1.000 | 0.990 | 0.856 |
| Rating | | V-0 | V-0 | V-0 | V-0 |

### Example 13

Samples 29-33 show moldability with different types of filler. Sample 29 shows that good moldability is obtained with silica. Samples 29-33 are prepared in accordance with Example 6. Amounts and data are shown in Table 13.

TABLE 13

| Component | 29 | 30 | 31 | 32 | 33 |
|---|---|---|---|---|---|
| PPO | 90.25 | 90.25 | 90.25 | 90.25 | 90.25 |
| CF2003 | 4.5 | 4.5 | 4.5 | 4.5 | 4.5 |
| Untreated Fumed Silica | 4.5 | | | | |
| Luperox ® 101XL | 0.75 | 0.75 | 0.75 | 0.75 | 0.75 |
| Talc | | 4.5 | | | |
| Calcium Carbonate | | | 4.5 | | |
| Magshield ® UF | | | | 4.5 | |
| Mica | | | | | 4.5 |
| Test Results | | | | | |
| Molding | Good | CNM | CNM | CNM | CNM |
| Appearance | Good | N/A | N/A | N/A | N/A |

CNM = Could Not Be Molded

While typical embodiments have been set forth for the purpose of illustration, the foregoing descriptions should not be deemed to be a limitation on the scope herein. Accordingly, various modifications, adaptations and alternatives may occur to one skilled in the art without departing from the spirit and scope herein.

1. A method for making a polyarylene ether copolymer comprising mixing a polyarylene ether, a hydroxyaromatic terminated siloxane reagent and an oxidant, and melt compounding the mixture.

2. The method of claim 1 wherein the polyarylene ether has the structure (1): 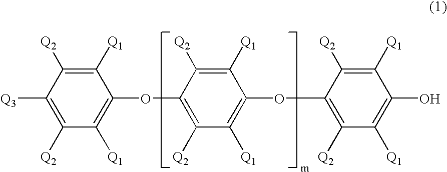
wherein each Q₁ is independently hydrogen, a primary or secondary alkyl group having from 1 to 7 carbon atoms, phenyl, haloalkyl, aminoalkyl, hydrocarbonoxy, or halohydrocarbonoxy wherein at least two carbon atoms separate the halogen and oxygen atoms; each Q₂ is independently hydrogen, halogen, a primary or secondary alkyl group having from 1 to 7 carbon atoms, phenyl, haloalkyl, aminoalkyl, hydrocarbonoxy, or halohydrocarbonoxy wherein at least two carbon atoms separate the halogen and oxygen atoms; Q₃ is a hydrogen, a hydroxyl group or a mixture thereof, and m is an integer having an average value in the range from about 3 to about 300.

3. The method of claim 1 wherein polyarylene ether is polyphenylene ether.

4. The method of claim 1 wherein the polyarylene ether has an intrinsic viscosity in the range of about 0.1 to about 1.3 dl/g as measured in chloroform at 25° C.

5. The method of claim 1 wherein the hydroxyaromatic terminated siloxane reagent has the formula: 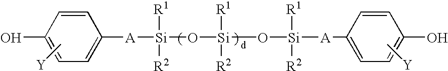
wherein each A is independently a direct link or a substituted or unsubstituted (C₁-C₁₅) alkyl or (C₂-C₁₅)alkylene; each Y is independently H, (C₁-C₆)alkyl or (C₁-C₆)alkoxyl, each R¹ and R² is independently H, a primary or secondary haloalkyl having from 1 to 12 carbon atoms, a primary or secondary alkyl group having from 1 to 12 carbon atoms, an aryl group having from 6 to 12 carbon atoms or an aralkyl group having from 7 to 18 carbon atoms; and d is an integer from 1 to 1,000,000.

6. The method of claim 1 wherein the hydroxyaromatic terminated siloxane reagent is a eugenol end-capped siloxane.

7. The method of claim 5 wherein d is an integer from 5 to 200.

8. The method of claim 1 wherein the oxidant is selected from the group consisting of: benzoylperoxide, dicumylperoxide, quinone, dimethylquinone, tetramethylquinone, 1,1,4,4-tetramethyltetramethylene bis(tert-butyl peroxide) and tetramethyldiphenoquinone (TMDQ).

9. The method of claim 1 wherein the reactants are melt compounded in an extruder.

10. The method of claim 9 wherein the reactants are uniformly dispersed and fed to the feedthroat of the extruder.

11. The method of claim 9 wherein the polyarylene ether and the hydroxyaromatic terminated siloxane are fed to the feedthroat of the extruder and the oxidant is fed to the extruder downstream from the feedthroat of the extruder.

12. The method of claim 9 wherein the hydroxyaromatic terminated siloxane is in liquid form.

13. The method of claim 12 wherein the hydroxyaromatic terminated siloxane is premixed with at least a partial amount of the polyarylene ether.

14. The method of claim 13 wherein the polyarylene ether premixed with the hydroxyaromatic terminated siloxane is in powder form.

15. The method of claim 1 wherein the polyarylene ether is in an amount from about 50 percent by weight to about 98.5 percent by weight, the hydroxyaromatic terminated siloxane reagent is in an amount from about 0.5 percent by weight to about 11 percent by weight and the oxidant is in an amount from about 1 to about 2 percent by weight, wherein the percent by weights are based on the weight of the mixture.

16. The method of claim 1 wherein the mixture further comprises a processing aid.

17. The method of claim 1 wherein the processing aid comprises a phosphate ester.

18. The method of claim 16 wherein the processing aid is present in an amount of from about 1 percent by weight to about 15 percent by weight based on the weight of the mixture.

19. The method of claim 1 wherein the mixture further comprises a filler.

20. The method of claim 19 wherein the filler is a silica or calcined aluminosilicate.

21. The method of claim 20 wherein the silica is a fumed silica.

22. The method of claim 21 wherein the silica is a D4 cyclic polyorganosiloxane treated fumed silica.

23. The method of claim 15 wherein the filler is present in a ratio of filler to hydroxyaromatic terminated siloxane reagent ranging from about 0.3:1 to about 2:1.

24. The method of claim 19 wherein the combined amount of filler and hydroxyaromatic terminated siloxane reagent is present in an amount up to about 20 percent by weight based on the weight of the composition.

25. The method of claim 19 wherein the filler is premixed with the hydroxyaromatic terminated siloxane reagent and the premix is added to the feedthroat of an extruder in a feedstream and the oxidant and polyarylene ether are added to the extruder in separate feedstreams.

26. The method of claim 19 wherein the polyarylene ether, hydroxyaromatic terminated siloxane reagent and filler is fed to the throat of an extruder and the oxidant is fed to the extruder downstream from the feedthroat.

27. The method of claim 19 wherein the polyarylene ether and filler are added to the feedthroat of an extruder and a mixture of the hydroxyaromatic terminated siloxane reagent and oxidant are added downstream in the extruder.

28. The method of claim 19 wherein the polyarylene ether, hydroxyaromatic terminated silxoane reagent and filler are compounded in an extruder in a first compounding step and the extrudate is compounded in a second compounding step with the oxidant to produce the copolymer.

29. A composition comprising a polyarylene ether, a hydroxyaromatic terminated siloxane reagent, oxidant and filler.

30. The composition of claim 29 wherein the polyarylene ether has the structure (1): 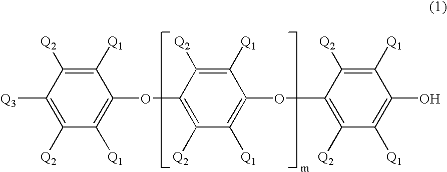
wherein each Q₁ is independently hydrogen, a primary or secondary alkyl group having from 1 to 7 carbon atoms, phenyl, haloalkyl, aminoalkyl, hydrocarbonoxy, or halohydrocarbonoxy wherein at least two carbon atoms separate the halogen and oxygen atoms; each Q₂ is independently hydrogen, halogen, a primary or secondary alkyl group having from 1 to 7 carbon atoms, phenyl, haloalkyl, aminoalkyl, hydrocarbonoxy, or halohydrocarbonoxy wherein at least two carbon atoms separate the halogen and oxygen atoms; Q₃ is a hydrogen, a hydroxyl group or a mixture thereof, and m is an integer having an average value in the range from about 3 to about 300.

31. The composition of claim 29 wherein polyarylene ether is polyphenylene ether.

32. The composition of claim 29 wherein the polyarylene ether has an intrinsic viscosity in the range of about 0.1 to about 1.3 dl/g as measured in chloroform at 25° C.

33. The composition of claim 29 wherein the hydroxyaromatic terminated siloxane reagent has the formula: 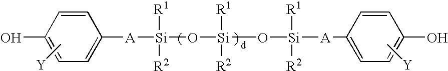
wherein each A is independently a direct link or a substituted or unsubstituted (C₁-C₁₅) alkyl or (C₂-C₁₅)alkylene; each Y is independently H, (C₁-C₆)alkyl or (C₁-C₆)alkoxyl, each R¹ and R² is independently H, a primary or secondary haloalkyl having from 1 to 12 carbon atoms, a primary or secondary alkyl group having from 1 to 12 carbon atoms, an aryl group having from 6 to 12 carbon atoms or an aralkyl group having from 7 to 18 carbon atoms; and d is an integer from 1 to 1,000,000.

34. The composition of claim 33 wherein the hydroxyaromatic terminated siloxane reagent is a eugenol end-capped siloxane.

35. The composition of claim 33 wherein d is an integer from 5 to 200.

36. The composition of claim 29 wherein the oxidant is selected from the group consisting of: benzoylperoxide, dicumylperoxide, quinone, dimethylquinone, tetramethylquinone, 1,1,4,4-tetramethyltetramethylene bis(tert-butyl peroxide) and tetramethyldiphenoquinone (TMDQ).

37. The composition of claim 29 wherein the polyarylene ether is in an amount from about 50 percent by weight to about 98.5 percent by weight, the hydroxyaromatic terminated siloxane reagent is in an amount from about 0.5 percent by weight to about 11 percent by weight and the oxidant is in an amount from about 1 to about 2 percent by weight, wherein the percent by weights are based on the weight of the mixture.

38. The composition of claim 29 wherein the composition further comprises a processing aid.

39. The composition of claim 29 wherein the processing aid comprises a phosphate ester.

40. The composition of claim 38 wherein the processing aid is present in an amount of from about 1 percent by weight to about 15 percent by weight based on the weight of the composition.

41. The composition of claim 29 wherein the filler is a silica or calcined aluminosilicate.

42. The composition of claim 41 wherein the silica is a fumed silica.

43. The composition of claim 42 wherein the silica is a D4 cyclic polyorganosiloxane treated fumed silica.

44. The composition of claim 40 wherein the filler is present in a ratio of filler to hydroxyaromatic terminated siloxane reagent ranging from about 0.3:1 to about 2:1.

45. The composition of claim 40 wherein the combined amount of filler and hydroxyaromatic terminated siloxane reagent is present in an amount up to about 20 percent by weight based on the weight of the composition.

46. The composition of claim 42 wherein the polyarylene ether is polyphenylene ether and is present in an amount from about 86 to about 93.3 percent by weight, the hydroxyaromatic terminated siloxane is eugenol end-capped siloxane reagent and is present in an amount from about 3 to about 6 percent by weight, the fumed silica is in an amount of from about 3 to about 6 percent by weight, the oxidant is peroxide and is present in an amount from about 0.7 to about 2 percent by weight and said ratio of fumed silica to eugenol end-capped siloxane reagent is 1:1 and wherein the percent by weights are based on the weight of the composition.

47. The composition of claim 46 wherein the polyphenylene ether is present in an amount of about 90.25 percent by weight, the eugenol end-capped siloxane reagent is present in an amount of about 4.5 percent by weight, the fumed silica is present in an amount of about 4.5 percent by weight, the peroxide is present in an amount of about 0.75 percent by weight and wherein the percent by weights are based on the weight of the composition.

48. The composition of claim 46 wherein the composition has a V-0 UL94 rating at a sample thickness of 1.5 mm.

49. The composition of claim 47 wherein the composition has a 5VA and 5VB UL94 rating at a sample thickness of 1 mm.

50. The composition of claims 46, wherein the composition has a smoke density selected from the group consisting of:
(i) a smoke density at four minutes of 5 to 100 as determined by ASTM E662 using samples having a thickness of 1.5 millimeters,
(ii) a maximum smoke density of 20 to 150 in the initial 20 minutes as determined by ASTM E662 using samples having a thickness of 1.5 millimeters,
(iii) a maximum smoke density of 20 to 300 in the initial 20 minutes as determined by ASTM E662 using samples having a thickness of 3.2 millimeters,
(iv) a smoke density at four minutes of 5 to 230 as determined by ASTM E662 using samples having a thickness of 3.2 millimeters, and
(v) a combination of two or more of the foregoing smoke densities.

51. The composition of claim 46 wherein the composition has been injection molded.

52. The composition of claim 46 wherein the composition has been extruded.

53. A film formed from the composition of claim 46.

54. A composition comprising polyphenylene ether in an amount from about 86 to about 93.3 percent by weight, eugenol end-capped siloxane reagent in an amount from about 3 to about 6 percent by weight, fumed silica in an amount from about 3 to about 6 percent by weight, peroxide in an amount from about 0.7 to about 2 percent by weight wherein said ratio of fumed silica to eugenol end-capped siloxane reagent is 1:1 and wherein the percent by weights are based on the weight of the composition.

55. A composition comprising polyphenylene ether in an amount of about 90.25 percent by weight, eugenol end-capped siloxane reagent in an amount of about 4.5 percent by weight, fumed silica in an amount of about 4.5 percent by weight, peroxide in an amount of about 0.75 percent by weight and wherein the percent by weights are based on the weight of the composition.
